(19) United States
(12) Patent Application Publication
(10) Pub. No.: US 2023/0032768 A1
(43) Pub. Date: Feb. 2, 2023

(54) STAPLER

(71) Applicant: MAX CO., LTD., Tokyo (JP)

(72) Inventor: Tatsuya Kenjo, Tokyo (JP)

(73) Assignee: MAX CO., LTD., Tokyo (JP)

(21) Appl. No.: 17/874,113

(22) Filed: Jul. 26, 2022

(30) Foreign Application Priority Data
Jul. 30, 2021 (JP) 2021-126175

(51) Int. Cl. B25C 5/02; B25C 5/11

(52) U.S. Cl. CPC B25C 5/0207; B25C 5/11

(57) ABSTRACT

A stapler includes a staple ejection unit configured to eject a staple and cause the staple to penetrate an object, a stitching unit configured to bend staple legs of the staple penetrating the object, and a driving unit configured to move the staple ejection unit in a direction close to and away from the stitching unit along a first direction indicated by an arrow. The staple ejection unit has an ejection surface from which the staple is ejected, and a base surface located between the ejection surface and the driving unit, the stitching unit has a bending surface facing the ejection surface and configured to bend the staple legs, and the ejection surface protrudes with respect to the base surface in the direction of the bending surface along the first direction.

### CROSS-REFERENCE TO RELATED APPLICATION(S)

This application is based on and claims priority under 35 USC § 119 from Japanese Patent Application No. 2021-126175 filed on Jul. 30, 2021, the contents of which are incorporated herein by reference.

### TECHNICAL FIELD

The disclosure relates to a stapler for stitching an object with a staple.

### BACKGROUND ART

Generally, a stapler has a configuration of stitching an object by sandwiching the object between a staple ejection unit having a magazine in which staples are stored, and a stitching unit having a staple receiving part, causing staple legs of the staple to penetrate the object, and bending the staple legs penetrating the object by the staple receiving part.

In such a stapler, by rotating the base end side of the staple ejection unit and the stitching unit with a shaft as a fulcrum, the tip end side of the staple ejection unit and the stitching unit is moved in a direction close to and away from each other, and the object is stitched on the tip end side of the staple ejection unit and the stitching unit. However, in a stapler having such a configuration, for example, in a case where stitching a booklet and the like having a flat surface, there is no problem, but in a case where trying to stitch an object having a convex portion on the surface, the convex portion may interfere with the staple ejection unit or the stitching unit, and the object may not be stitched well (the convex portion prevents the staple ejection unit and the stitching unit from coming close to each other).

In this regard, a technique has been proposed in which a staple receiving part is made higher than a base serving as the foundation of the stapler (e.g., see PTL 1).

### CITATION LIST

### Patent Literature

PTL 1: JP2012-000744A

However, in a stapler in which the staple receiving part is made higher, since the staple receiving part is high, when stitching an object having a convex portion on the stitching unit side, it is possible to stitch the object while avoiding (straddling) the convex portion, but it is not possible to stitch an object having a convex portion on the staple ejection unit side because the staple ejection unit interferes with the convex portion.

### SUMMARY

Therefore, the disclosure provides a stapler capable of stitching an object to be stitched with a staple without a staple ejection unit interfering with the object even in a case where stitching the object in which a convex portion is provided on the staple ejection unit side of the stapler.

In order to solve the above-described problem, a stapler includes: a staple ejection unit configured to eject a staple and cause the staple to penetrate an object; a stitching unit configured to bend staple legs of the staple penetrating the object; and a driving unit configured to move the staple ejection unit and the stitching unit in a direction close to and away from each other along a first direction. The staple ejection unit includes an ejection surface from which the staple is ejected, and a base surface located between the ejection surface and the driving unit. The stitching unit includes a bending surface facing the ejection surface and configured to bend the staple legs. The ejection surface protrudes with respect to the base surface in a direction of the bending surface along the first direction.

### BRIEF DESCRIPTION OF DRAWINGS

FIG. 1 is a side view showing an example of a stapler of the present embodiment.

FIG. 2 is a perspective view showing an example of the stapler of the present embodiment.

FIG. 3 is a broken side view of a main part showing an example of the stapler of the present embodiment.

FIG. 4A is a side view showing an example of an operation of the stapler of the present embodiment.

FIG. 4B is a side view showing an example of an operation of the stapler of the present embodiment.

FIG. 4C is a side view showing an example of an operation of the stapler of the present embodiment.

FIG. 4D is a side view showing an example of an operation of the stapler of the present embodiment.

FIG. 4E is a side view showing an example of an operation of the stapler of the present embodiment.

FIG. 5A is a side view showing a modified example of the stapler of the present embodiment.

FIG. 5B is a side view showing a modified example of the stapler of the present embodiment.

FIG. 5C is a side view showing a modified example of the stapler of the present embodiment.

FIG. 6 is a side view showing another modified example of the stapler of the present embodiment.

FIG. 7 is a perspective view showing an example of a bending surface.

### DESCRIPTION OF EMBODIMENTS

Hereinafter, embodiments of a stapler of the present embodiment will be described with reference to the drawings.

### Configuration Example of the Stapler of the Present Embodiment

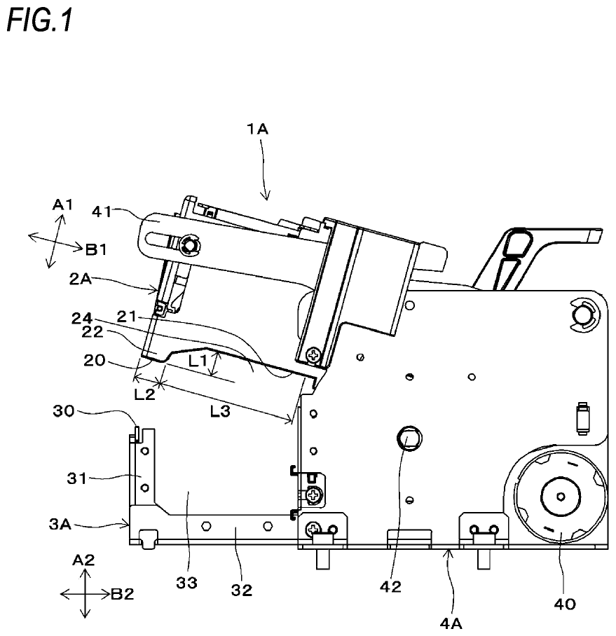

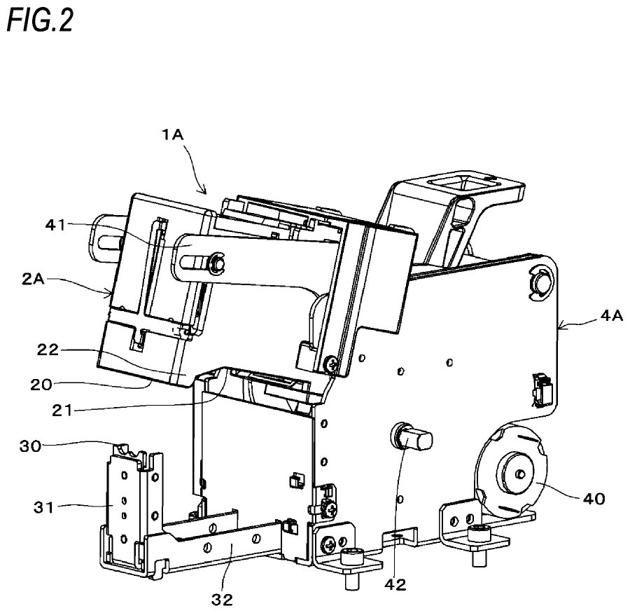

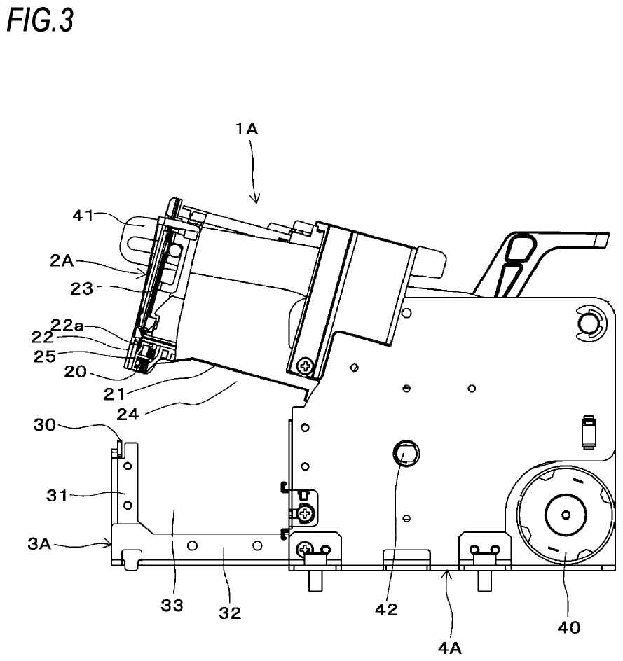

FIG. 1 is a side view showing an example of a stapler of the present embodiment, FIG. 2 is a perspective view showing an example of the stapler of the present embodiment, and FIG. 3 is a broken side view of a main part showing an example of the stapler of the present embodiment.

A stapler 1A of the present embodiment includes a staple ejection unit 2A that ejects a staple (not shown) and causes the staple to penetrate an object, a stitching unit 3A that bends staple legs of the staple penetrating the object, and a driving unit 4A that moves the staple ejection unit 2A and the stitching unit 3A along a first direction indicated by an arrow A1 in a direction close to and away from each other.

Meanwhile, in the stapler 1A, in this example, the staple ejection unit 2A rotates around a drive shaft 42 as a fulcrum, and moves in a direction close to and away from the stitching unit 3A. Therefore, the moving direction along the first direction indicated by the arrow A1 includes not only the direction along a straight line but also the direction along a curve such as an arc. Further, since the angle of the staple ejection unit 2A with respect to the stitching unit 3A changes according to the movement of the staple ejection unit 2A due to the rotational operation, the angle of the first direction indicated by the arrow A1 changes according to the movement of the staple ejection unit 2A due to the rotational operation. FIG. 1 shows the first direction in a standby position in which the staple ejection unit 2A is moved in a direction away from the stitching unit 3A, and an object is not sandwiched.

The staple ejection unit 2A has an ejection surface 20 from which a staple is ejected, and a base surface 21 located between the ejection surface 20 and the driving unit 4A. Further, the stitching unit 3A includes a bending surface forming unit 31 having a bending surface 30 for bending staple legs of a staple, and a base member 32 located between the bending surface forming unit 31 and the driving unit 4A.

The staple ejection unit 2A is in a form of protruding from the driving unit 4A along a second direction indicated by an arrow B1. Meanwhile, the second direction indicated by the arrow B1 includes not only the direction orthogonal to the first direction indicated by the arrow A1 but also the direction intersecting with the first direction at a predetermined angle other than parallel.

In the staple ejection unit 2A, a staple ejection passage forming unit 22 protruding along the first direction in the direction of the stitching unit 3A is provided at an end portion side protruding along the second direction from the driving unit 4A. Further, in the staple ejection unit 2A, the ejection surface 20 is provided on the surface of the staple ejection passage forming unit 22 facing the bending surface 30. Furthermore, in the staple ejection unit 2A, the base surface 21 is provided between the staple ejection passage forming unit 22 and the driving unit 4A so as to face the stitching unit 3A. The base surface 21 is recessed with respect to the ejection surface 20 between the ejection surface 20 and the driving unit 4A in a direction away from the stitching unit 3A, whereby a recessed portion 24 is formed between the ejection surface 20 and the driving unit 4A. Meanwhile, in the staple ejection unit 2A, the end portion side protruding along the second direction from the driving unit 4A is referred to as the front side.

In the staple ejection passage forming unit 22, a driver 23 for ejecting a staple and a passage 22a through which the staple ejected by the driver 23 passes are formed. Further, in the staple ejection passage forming unit 22, a pressing member 25 for regulating the direction of the staple passing through the passage 22a is provided. The ejection surface 20 is provided with an opening which communicates with the passage 22a and through which the staple passes.

The stitching unit 3A has a form in which the base member 32 protrudes from the driving unit 4A along a third direction indicated by an arrow B2. Meanwhile, in a standby position in which the staple ejection unit 2A is moved in a direction away from the stitching unit 3A and an object is not sandwiched, the second direction and the third direction differ from each other by a predetermined angle. On the other hand, in a stitching position in which the staple ejection unit 2A is moved in a direction close to the stitching unit 3A and an object is sandwiched, the second direction and the third direction are substantially parallel.

In the stitching unit 3A, the bending surface forming unit 31 protruding along a fourth direction indicated by an arrow A2 in the direction of the staple ejection unit 2A is provided at an end portion side of the base member 32 protruding along the third direction from the driving unit 4A. Further, in the stitching unit 3A, the bending surface 30 is provided on the surface of the bending surface forming unit 31 facing the ejection surface 20. The bending surface 30 is provided with a groove portion having a predetermined shape for bending staple legs of a staple. The base member 32 is recessed between the bending surface forming unit 31 and the driving unit 4A in a direction away from the staple ejection unit 2A, whereby a recessed portion 33 is formed between the bending surface forming unit 31 and the driving unit 4A.

Meanwhile, the fourth direction indicated by the arrow A2 includes not only the direction orthogonal to the third direction indicated by the arrow B2 but also the direction intersecting with the third direction at a predetermined angle other than parallel. Further, in the standby position in which the staple ejection unit 2A is moved in a direction away from the stitching unit 3A and an object is not sandwiched, the fourth direction and the first direction differ from each other by a predetermined angle. On the other hand, in the stitching position in which the staple ejection unit 2A is moved in a direction close to the stitching unit 3A and an object is sandwiched, the fourth direction and the first direction are substantially parallel. Furthermore, in the stitching unit 3A, the end portion side protruding along the third direction from the driving unit 4A is referred to as the front side.

The driving unit 4A is driven and actuated by a motor 40 to move the staple ejection unit 2A along the first direction in a direction close to and away from the stitching unit 3A. Further, the driving unit 4A includes a link 41 for converting the rotation of the motor 40 into the movement of the driver 23, and operates the driver 23 by the link 41 to eject the staple in conjunction with the operation of moving the staple ejection unit 2A in a direction close to the stitching unit 3A.

In the stapler 1A, a protrusion amount L1 of the ejection surface 20 along the first direction with respect to the base surface 21 is not smaller than 1.5 mm. A convex amount of a blister part (convex part) differs depending on an item to be included in a blister pack. However, according to the investigation of various blister packs on the market, a blister pack with the smallest convex amount in the confirmed range was a blister pack containing a replacement blade of a cutter knife, and the convex amount thereof was about 1.5 mm. From this, it is preferable that the protrusion amount L1 of the ejection surface 20 of the stapler 1A is at least 1.5 mm or more. Meanwhile, in this example, the base surface 21 is substantially flat. However, for example, when the base surface 21 has an uneven shape, with reference to the surface of the base surface 21 that most protrudes toward the stitching unit 3A, the distance from the most protruding surface to the ejection surface 20 is defined as the protrusion amount L1 (hereinafter, the same applies in this specification).

Although the protrusion amount L1 of the ejection surface 20 is at least 1. 5 mm or more as described above, the protrusion amount L1 is preferably not smaller than 3 mm, and more preferably not smaller than 6 mm in order to stitch more types of blister packs. On the other hand, the upper limit of the protrusion amount L1 is preferably not greater than 100 mm in order to suppress an increase in the dimensions of the stapler 1A along the first direction. According to the stapler as described above, the object is not limited to the blister pack, and the stapler can stitch other objects that are expected to be convex, such as an object with a clip, a button, or the like exposed on the surface.

In the stapler 1A, a length L2 of the ejection surface 20 along the second direction is not smaller than 3 mm and not greater than 20 mm. The reason for this is as follows. When the length L2 of the ejection surface 20 along the second direction is less than 3 mm, the pressing force for regulating the direction of the staple is insufficient, and there is a possibility that the driving failure of the staple may occur. Further, when the length L2 of the ejection surface 20 along the second direction is 20 mm or more, the ejection surface interferes with the convex portion of the object, and the object that can be stitched is limited.

In the stapler 1A, a length L3 of the base surface 21 along the second direction is not smaller than 5 mm. Meanwhile, the length L3 of the base surface 21 along the second direction is a length of the recessed portion 24 along the second direction. In the stapler 1A, the length L3 of the base surface 21 along the second direction is preferably not smaller than 15 mm, and more preferably not smaller than 30 mm. Further, in the stapler 1A, the upper limit of the length L3 of the base surface 21 along the second direction is preferably not greater than 100 mm in order to suppress an increase in the dimensions of the stapler 1A along the second direction.

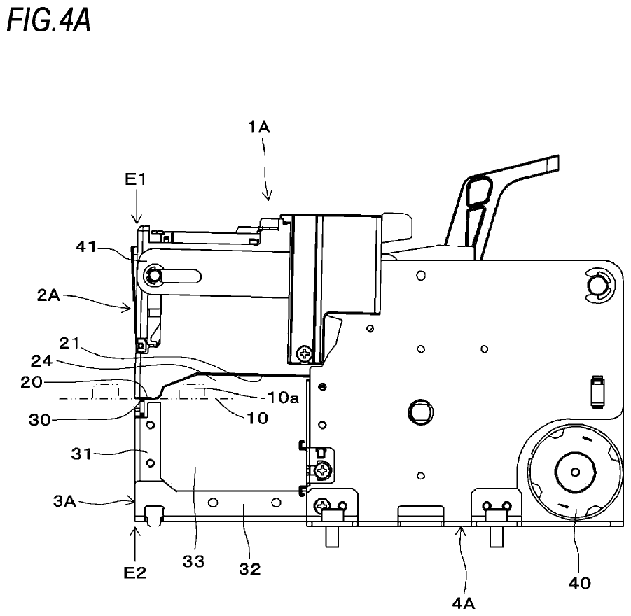

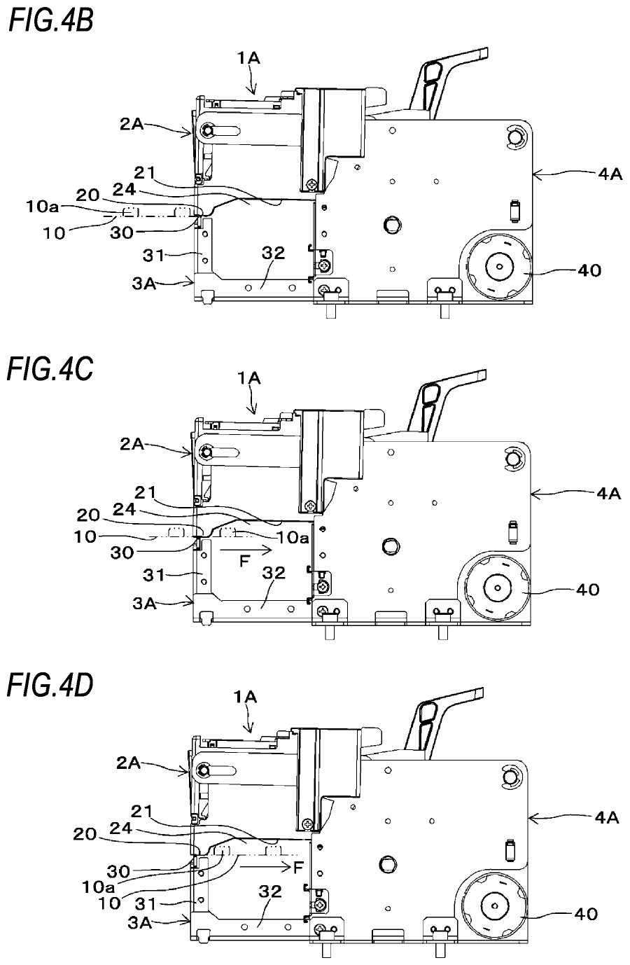

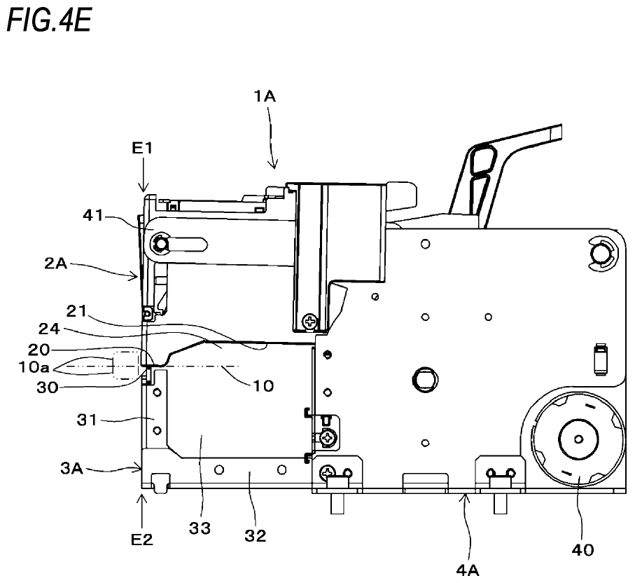

As described above, in this example, the length L3 of the base surface 21 along the second direction is set to 5 mm or more, and the reason for this is as follows. That is, when the inventors investigated various objects (blister packs) having convex portions, they found that there were almost no objects in which the width (depth) of the convex portion is less than 5 mm, and even the smallest width that could be confirmed was about 4 mm to 5 mm (for example, when stitching an end of a roll curtain, it is necessary to stitch a cloth part of the curtain across a stopper part, but the size of the stopper part was about 4 mm or 5 mm). Further, when the length L3 is 15 mm or more, it is possible to stitch many of the relatively small blister packs. When the length L3 is 30 mm or more, it is possible to stitch most of the small blister packs. Furthermore, when the length L3 is 30 mm or more, it is possible to continuously stitch an object (for example, a package of a small-diameter drill) having a plurality of convex portions on the surface without changing the orientation as shown in FIGS. 4B to 4D.

### Operation Example of the Stapler of the Present Embodiment

FIGS. 4A to 4E are side views showing an example of the operation of the stapler of the present embodiment.

As shown in FIG. 1, when the stapler 1A is in the standby position in which the staple ejection unit 2A is moved in a direction away from the stitching unit 3A, an object 10 to be stitched is inserted between the bending surface 30 and the ejection surface 20.

In the stapler 1A, when the motor 40 of the driving unit 4A is driven by a predetermined operation, and the staple ejection unit 2A moves in a direction close to the stitching unit 3A, the object 10 is sandwiched between the ejection surface 20 and the bending surface 30, as shown in FIG. 4A. Further, the driver 23 operates in conjunction with the movement operation of the staple ejection unit 2A in the direction close to the stitching unit 3A, the staple is ejected from the ejection surface 20.

The staple legs of the staple ejected from the ejection surface 20 penetrate the object and are bent into a predetermined shape by the bending surface 30, so that the object is stitched with the staple.

In the case where a convex portion 10a is provided on the surface of the object 10 facing the base surface 21 and between the ejection surface 20 and the driving unit 4A, the convex portion 10a enters the recessed portion 24 when the staple ejection unit 2A moves in the direction close to the stitching unit 3A and moves to the stitching position. In this way, even when the object 10 has the convex portion 10a, the stitching position of the object 10 can be sandwiched between the ejection surface 20 and the bending surface 30, whereby the object 10 can be stitched with the staple.

When stitching the object 10 with the stapler 1A, the staple crown of the staple is exposed on the side of the object 10 facing the ejection surface 20. Therefore, when the convex portion 10a is provided on the surface of the object 10 to be stitched with the stapler 1A facing the base surface 21 and between the ejection surface 20 and the driving unit 4A, the object 10 can be stitched such that the staple crown of the staple is exposed on the surface on which the convex portion 10a is provided. Generally, since a package using a transparent blister is displayed such that a convex product 10a can be seen, it is desirable that the staple crown side stitched by the stapler is the product 10a-side.

Meanwhile, in the case where a convex portion is also provided on the surface of the object 10 facing the base member 32 and between the bending surface 30 and the driving unit 4A, the convex portion enters the recessed portion 33 when the staple ejection unit 2A moves in the direction close to the stitching unit 3A and moves to the stitching position. In this way, even when the convex portions are provided on the front and back surfaces of the object 10, the stitching position of the object 10 can be sandwiched between the ejection surface 20 and the bending surface 30, whereby the object 10 can be stitched with the staple.

Further, when the staple ejection unit 2A moves to the stitching position, an end portion E1 on the tip end side of the staple ejection unit 2A is located on the same surface as an end portion E2 on the tip end side of the stitching unit 3A. In this way, even when the convex portion 10a provided on the object 10 is located outside the end portion E1 on the tip end side of the staple ejection unit 2A, or as shown in FIG. 4E, even when the convex portion 10a is located outside the end portion E2 on the tip end side of the stitching unit 3A, the staple ejection unit 2A and the stitching unit 3A are suppressed from coming into contact with the convex portion 10a, and the object 10 can be stitched with the staple.

Furthermore, in the case where the object 10 is provided with a plurality of convex portions 10a and the stitching positions are provided on both sides of the convex portion 10a, when the length L3 of the base surface 21 along the second direction is equal to or greater than the value specified in the disclosure, as shown in FIGS. 4B to 4D, the stapler 1A can stitch a plurality of points of the object 10 with staples by an operation of moving the staple ejection unit 2A in a direction close to and away from the stitching unit 3A and an operation of moving the object 10 in a direction of an arrow F without rotating the object 10 or the stapler 1A.

### Modified Example of the Stapler of the Present Embodiment

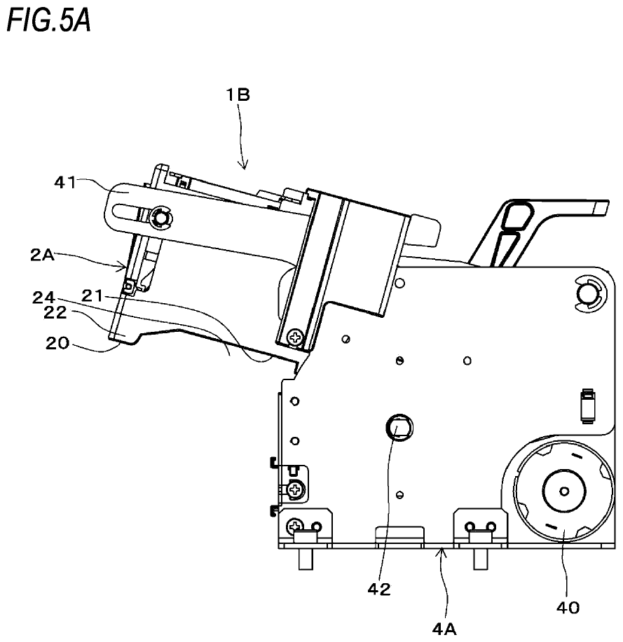

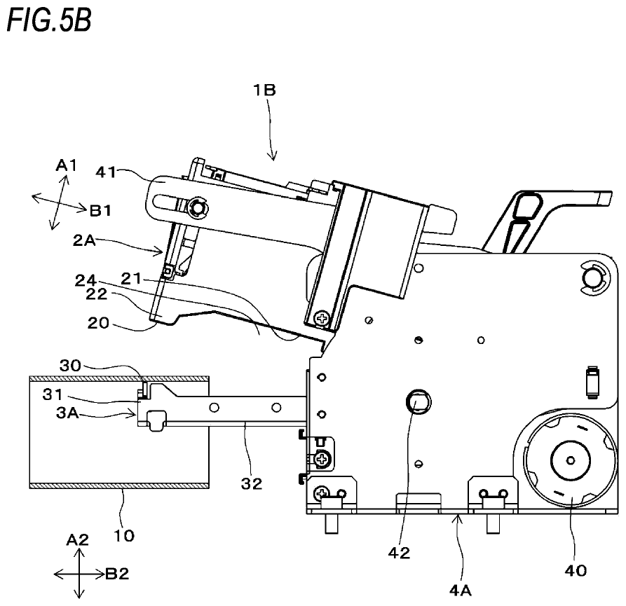

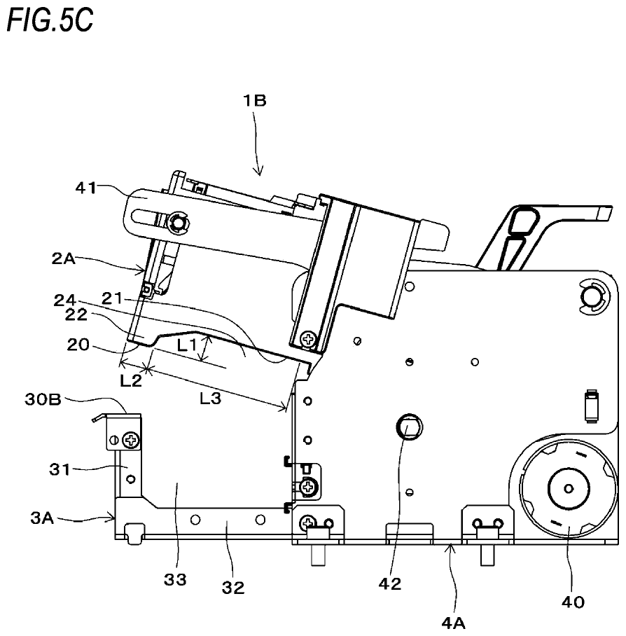

FIGS. 5A, 5B and 5C are side views showing a modified example of the stapler of the present embodiment. A stapler 1B of the modified example is configured such that the stitching unit 3A described with reference to FIG. 1 and the like is detachably attached to the driving unit 4A. As shown in FIG. 5A, by detaching the stitching unit 3A, the stapler 1B can be used in a form of stitching an object without bending staple legs of a staple. Further, as shown in FIG. 5B, the stapler 1B can also be used to stitch, for example, a cylindrical object 10 by attaching the stitching unit 3A in which the attachment position of the base member 32 in the fourth direction indicated by the arrow A2, and the configurations of the bending surface 30 and the bending surface forming unit 31 are different.

Meanwhile, the protruding portion of the stitching unit 3A with respect to the base member 32 including the bending surface 30 may be configured to be detachably attached to the other portion of the stitching unit 3A. Further, as shown in FIG. 5C, the bending surface 30 may be configured to be detachably attached to the bending surface forming unit 31, or may be replaced with a bending surface 30B having a stand on which an object is placed, or may be replaced with another bending surface having a different shape for bending staple legs of a staple. Further, in the staple ejection unit 2A, the protrusion amount of the ejection surface 20 with respect to the base surface 21 may be adjustable. Furthermore, the protruding portion of the staple ejection unit 2A with respect to the base surface 21 including the ejection surface 20 may be configured to be detachably attached to the other portion of the staple ejection unit 2A.

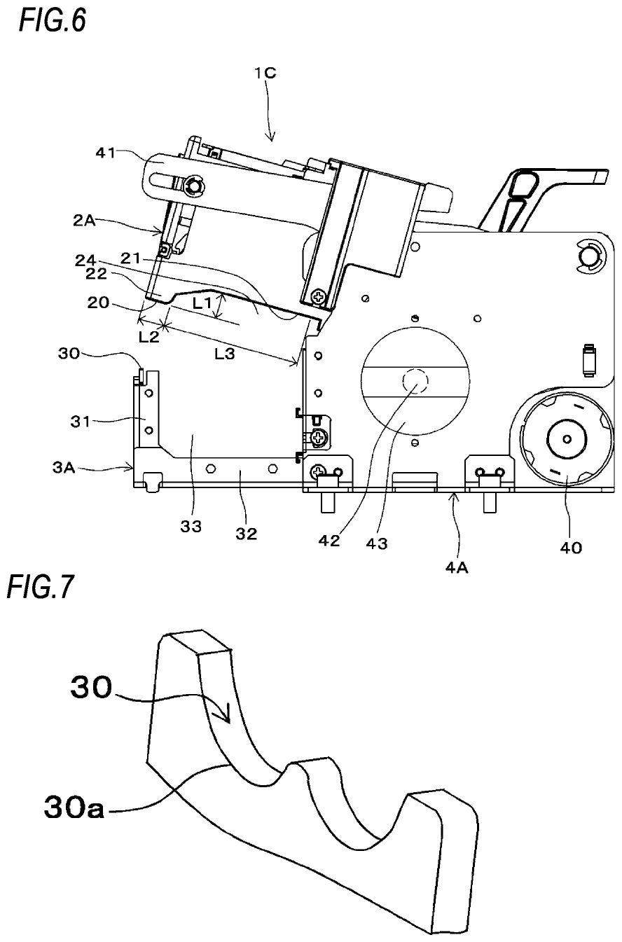

FIG. 6 is a side view showing another modified example of the stapler of the present embodiment. In a stapler 1C of another modified example, a handle 43 that can be operated by hand is provided on the drive shaft 42 driven by the motor 40, and the driving unit 4A can be operated in a non-drive state of the motor 40. Meanwhile, the stapler 1C may be configured to be operated only manually without including the motor 40.

FIG. 7 is a perspective view showing an example of the bending surface. The bending surface 30 is provided with an opening 30a at an end portion in a front end direction facing the tip end side of the stitching unit 3A, so that the staple legs of the staple bent by the bending surface 30 can be pulled out from the opening 30a toward the tip end side of the stitching unit 3A.

### ADDITIONAL NOTES

This application discloses at least the following inventions (1) to (18).

(1) A stapler includes:

a staple ejection unit configured to eject a staple and cause the staple to penetrate an object;

a stitching unit configured to bend staple legs of the staple penetrating the object; and

a driving unit configured to move the staple ejection unit and the stitching unit in a direction close to and away from each other along a first direction.

The staple ejection unit includes an ejection surface from which the staple is ejected, and a base surface located between the ejection surface and the driving unit.

The stitching unit includes a bending surface facing the ejection surface and configured to bend the staple legs.

The ejection surface protrudes with respect to the base surface in a direction of the bending surface along the first direction.

In the stapler, when the staple ejection unit and the stitching unit move in the direction close to each other, and the object is sandwiched between the ejection surface and the bending surface, a recess in the direction away from the stitching unit is maintained in the base surface between the ejection surface and the driving unit. In this way, in a case where the convex portion is provided on the object, the convex portion enters the recessed portion of the base surface.

According to the stapler described above, even in a case where the convex portion is provided on the surface of the object facing the base surface and between the ejection surface and the driving unit, the stitching position of the object can be sandwiched between the ejection surface and the bending surface, so that the object can be stitched with the staple.

(2) The stapler according to (1), a protrusion amount of the ejection surface with respect to the base surface along the first direction is not smaller than 1.5 mm.

(3) The stapler according to (2), the protrusion amount is not smaller than 3 mm.

(4) The stapler according to (3), the protrusion amount is not smaller than 6 mm.

(5) The stapler according to any one of (1) to (4), a protrusion amount of the ejection surface with respect to the base surface along the first direction is not greater than 100 mm.

(6) The stapler according to any one of (1) to (5), when a direction from the ejection surface to the base surface is defined as a second direction, a length of the ejection surface along the second direction is not smaller than 3 mm and not greater than 20 mm.

(7) The stapler according to (6), the length of the base surface along the second direction is not smaller than 5 mm.

(8) The stapler according to (7), the length of the base surface along the second direction is not smaller than 15 mm.

(9) The stapler according to (8), the length of the base surface along the second direction is not smaller than 30 mm.

(10) The stapler according to any one of (7) to (9), the length of the base surface along the second direction is not greater than 100 mm.

(11) The stapler according to any one of (1) to (10), a protrusion amount of the ejection surface with respect to the base surface along the first direction is configured to be adjustable.

(12) The stapler according to any one of (1) to (11), the stitching unit includes a base member between the bending surface and the driving unit. The bending surface protrudes in a direction of the ejection surface with respect to the base member.

(13) The stapler according to any one of (1) to (12), an end portion on a tip end side of the staple ejection unit and an end portion on a tip end side of the stitching unit are located on the same surface in a case where the staple ejection unit and the stitching unit move in a direction close to each other.

(14) The stapler according to any one of (1) to (13), the staple ejection unit includes a protruding portion with respect to the base surface including the ejection surface, the protruding portion is configured to be detachably attached to an other portion of the staple ejection unit.

(15) The stapler according to any one of (12) to (14), the stitching unit includes a protrusion portion with respect to the base member including the bending surface, the protruding portion is configured to be detachably attached to an other portion of the stitching unit.

(16) The stapler according to any one of (1) to (15), the stitching unit is configured to be detachably attached to the driving unit.

(17) The stapler according to any one of (1) to (16), the bending surface is open at an end portion in a direction toward a tip end of the stitching unit.

(18) The stapler according to any one of (1) to (17), further includes a handle configured to operate the driving unit.

(19) The stapler according to (12), in a case where the staple ejection unit and the stitching unit move in a direction close to each other, the direction of which the ejection surface protrudes with respect to the base member and the first direction are substantially parallel.

1. A stapler comprising:
a staple ejection unit configured to eject a staple and cause the staple to penetrate an object;
a stitching unit configured to bend staple legs of the staple penetrating the object; and
a driving unit configured to move the staple ejection unit and the stitching unit in a direction close to and away from each other along a first direction,
wherein the staple ejection unit includes an ejection surface from which the staple is ejected, and a base surface located between the ejection surface and the driving unit,
wherein the stitching unit includes a bending surface facing the ejection surface and configured to bend the staple legs, and
wherein the ejection surface protrudes with respect to the base surface in a direction of the bending surface along the first direction.

2. The stapler according to claim 1, wherein a protrusion amount of the ejection surface with respect to the base surface along the first direction is not smaller than 1.5 mm.

3. The stapler according to claim 2, wherein the protrusion amount is not smaller than 3 mm.

4. The stapler according to claim 3, wherein the protrusion amount is not smaller than 6 mm.

5. The stapler according to claim 3, wherein a protrusion amount of the ejection surface with respect to the base surface along the first direction is not greater than 100 mm.

6. The stapler according to claim 3, wherein when a direction from the ejection surface to the base surface is defined as a second direction, a length of the ejection surface along the second direction is not smaller than 3 mm and not greater than 20 mm.

7. The stapler according to claim 6, wherein the length of the base surface along the second direction is not smaller than 5 mm.

8. The stapler according to claim 7, wherein the length of the base surface along the second direction is not smaller than 15 mm.

9. The stapler according to claim 8, wherein the length of the base surface along the second direction is not smaller than 30 mm.

10. The stapler according to claim 7, wherein the length of the base surface along the second direction is not greater than 100 mm.

11. The stapler according to claim 1, wherein a protrusion amount of the ejection surface with respect to the base surface along the first direction is configured to be adjustable.

12. The stapler according to claim 3,
wherein the stitching unit includes a base member between the bending surface and the driving unit, and
wherein the bending surface protrudes in a direction of the ejection surface with respect to the base member.

13. The stapler according to claim 1, wherein an end portion on a tip end side of the staple ejection unit and an end portion on a tip end side of the stitching unit are located on the same surface in a case where the staple ejection unit and the stitching unit move in a direction close to each other.

14. The stapler according to claim 1, wherein the staple ejection unit includes a protruding portion with respect to the base surface including the ejection surface, the protruding portion is configured to be detachably attached to an other portion of the staple ejection unit.

15. The stapler according to claim 12, wherein the stitching unit includes a protrusion portion with respect to the base member including the bending surface, the protruding portion is configured to be detachably attached to an other portion of the stitching unit.

16. The stapler according to claim 1, wherein the stitching unit is configured to be detachably attached to the driving unit.

17. The stapler according to claim 1, wherein the bending surface is open at an end portion in a direction toward a tip end of the stitching unit.

18. The stapler according to claim 1, further comprising a handle configured to operate the driving unit.

19. The stapler according to claim 12, wherein in a case where the staple ejection unit and the stitching unit move in a direction close to each other, the direction of which the ejection surface protrudes with respect to the base member and the first direction are substantially parallel.
